(19) United States
(12) Patent Application Publication
(10) Pub. No.: US 2013/0014008 A1
(43) Pub. Date: Jan. 10, 2013

(54) Adjusting an Automatic Template Layout by Providing a Constraint

(76) Inventor: Niranjan Damera-Venkata, Mountain View, CA (US)

(21) Appl. No.: 13/634,793

(22) PCT Filed: Mar. 22, 2010
(86) PCT No.: PCT/US10/28147

§ 371 Date: Sep. 13, 2012

(51) Int. Cl. G06F 17/00

(52) U.S. Cl. 715/252

(57) ABSTRACT

One embodiment of a method for adjusting an automatic template layout by providing a constraint is disclosed. In one embodiment, raw text, figures, references, and semantic information is received. A check is performed for a constraint. An allocation of text, figures, and references is determined for each page of a document. In addition, for each page of the document, a template for displaying the allocation assigned to the page is determined. The template fields are scaled to exhibit the text, figures, and references assigned to the page. The document is then rendered with text, figures, and references allocated to each page within appropriate template fields of the template selected for each page while abiding by the constraint.

### TECHNICAL FIELD

The disclosure is related to the field of document layout, and in particular, to automatically generating and rendering a template for a pre-defined layout and any constraints associated therewith.

### BACKGROUND

A mixed-content document can be organized to display a combination of text, images, headers, sidebars, or any other elements that are typically dimensioned and arranged to display information to a reader in a coherent, informative, and visually aesthetic manner. Mixed-content documents can be in printed or electronic form, and examples of mixed-content documents include articles, flyers, business cards, newsletters, website displays, brochures, single or multi page advertisements, envelopes, and magazine covers just to name a few. In order to design a layout for a mixed-content document, a document designer selects for each page of the document a number of elements, element dimensions, spacing between elements called “white space,” font size and style for text, background, colors, and an arrangement of the elements.

In recent years, advances in computing devices have accelerated the growth and development of software-based document layout design tools and, as a result, increased the efficiency with which mixed-content documents can be produced. A first type of design tool uses a set of gridlines that can be seen in the document design process but are invisible to the document reader. The gridlines are used to align elements on a page, allow for flexibility by enabling a designer to position elements within a document, and even allow a designer to extend portions of elements outside of the guidelines, depending on how much variation the designer would like to incorporate into the document layout. A second type of document layout design tool is a template. Typical design tools present a document designer with a variety of different templates to choose from for each page of the document FIG. 1 shows an example of a template 100 for a single page of a mixed-content document. The template 100 includes two image fields 101 and 102, three text fields 104-106, and a header field 108. The text, image, and header fields are separated by white spaces. A white space is a blank region of a template separating two fields, such as white space 110 separating image field 101 from text field 105. A designer can select the template 100 from a set of other templates, input image data to fill the image fields 101 and text data to fill the text fields 104-106 and the header.

However, it is often the case that the dimensions of template fields are fixed making it difficult for document designers to resize images and arrange text to fill particular fields creating image and text overflows, cropping, or other unpleasant scaling issues. FIG. 2 shows the template 100 where two images, represented by dashed-line boxes 201 and 202, are selected for display in the image fields 101 and 102. As shown in the example of FIG. 2, the images 201 and 202 do not fit appropriately within the boundaries of the image fields 101 and 102. With regard to the image 201, a design tool may be configured to crop the image 201 to fit within the boundaries of the image field 101 by discarding peripheral, but visually import, portions of the image 201, or the design tool may attempt to fit the image 201 within the image field 101 by resealing the aspect ratio of the image 201, resulting in a visually displeasing distorted image 201. Because image 202 fits within the boundaries of image field 102 with room to spare, white spaces 204 and 206 separating the image 202 from the text fields 104 and 106 exceed the size of the white spaces separating other elements in the template 100 resulting in a visually distracting uneven distribution of the elements. The design tool may attempt to correct for this by resealing the aspect ratio of the image 202 to fit within the boundaries of the image field 102, also resulting in a visually displeasing distorted image 202.

### BRIEF DESCRIPTION OF THE DRAWINGS

FIG. 1 shows an example of a template for a single page of a mixed-content document.

FIG. 2 shows the template shown in FIG. 1 with two images selected for display in the image fields.

FIG. 3A shows a representation of a first single page template with dimensions identified in accordance with one example.

FIG. 3B shows vector characterization of template parameters and dimensions of an image and white spaces associated with the template shown in FIG. 3A in accordance with one example.

FIG. 4A shows a representation of a second single page template with dimensions identified in accordance with one example.

FIG. 4B shows vector characterization of template parameters and dimensions of images and white spaces associated with the template shown in FIG. 4A in accordance with one example.

FIG. 5A shows a representation of a third single page template with dimensions identified in accordance with one example.

FIG. 5B shows vector characterization of template parameters and dimensions of images and white spaces associated with the template shown in FIG. 5A in accordance with one example.

FIG. 6 shows an example of generating an optimized document layout from raw input in accordance with one example.

FIG. 7 shows a Bayesian network characterizing conditional independencies of allocations, templates, and template parameters in accordance with one example.

FIG. 8 shows a plot of a normal distribution for three different variances in accordance with one example.

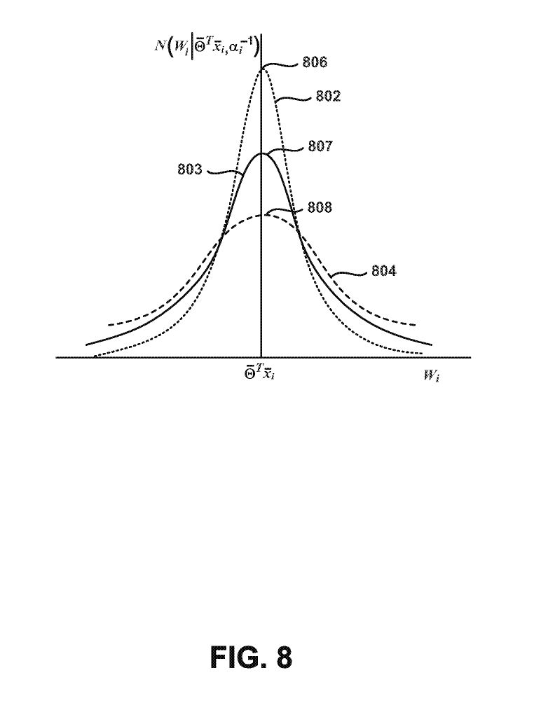

FIG. 9 shows a control-flow diagram of a method for generating a document layout in accordance with one example.

FIG. 10 shows a control-flow diagram of a method for executing a step in the control-flow diagram of FIG. 9 in accordance with one example.

FIG. 11 shows a control-flow diagram of a method executing a step in the control-flow diagram of FIG. 10 in accordance with one example.

FIG. 12 shows a schematic representation of a computing device configured in accordance with one example.

### DETAILED DESCRIPTION

An example of a method for adjusting an automatic template layout by providing a constraint is disclosed, in one example, raw text, figures, references, and semantic information is received. A check is performed for a constraint. An allocation of text and figures is determined for each page of a document. In addition, for each page of the document, a template for displaying the allocation assigned to the page is determined. The template parameters are set to exhibit the text and figures assigned to the page. The document is then rendered with text and figures allocated to each page within appropriate template fields of the template selected for each page while abiding by the constraint.

Examples are described below with reference to numerous equations and graphical illustrations. In particular, examples are based on Bayes' Theorem from the probability theory branch of mathematics. Although mathematical expressions alone may be sufficient to fully describe and characterize examples disclosed herein, the more graphical, problem oriented examples, and control-flow-diagram approaches included in the following discussion are intended to illustrate examples so that the systems and methods may be accessible to readers with various backgrounds. In order to assist in understanding descriptions of various examples disclosed herein, an overview of Bayes' Theorem is provided in a first subsection, template parameters are introduced in a second subsection, and probabilistic template models based Bayes' Theorem for determining template parameters are provided in a third subsection.

An Overview of Bayes' Theorem and Related Concepts from Probability Theory

Readers already familiar with Bayes' Theorem and other related concepts from probability theory can skip this subsection and proceed to the next subsection titled Template Parameters. This subsection is intended to provide readers who are unfamiliar with Bayes' Theorem a basis for understanding relevant terminology, notation, and provide a basis for understanding how Bayes' Theorem is used to determine document template parameters as described below. For the sake of simplicity, Bayes' theorem and related topics are described below with reference to sample spaces with discrete events, but one skilled in the art will recognize that these concepts can be extended to sample spaces with continuous distributions of events.

A description of probability begins with a sample space S, which is the mathematical counterpart of an experiment and mathematically serves as a universal set for all possible outcomes of an experiment. For example, a discrete sample space can be composed of all the possible outcomes of tossing a fair coin two times and is represented by:

S={HH+HT+TH+TT}

where H represents the outcome heads, and T represents the outcome tails. An event is a set of outcomes, or a subset of a sample space, to which a probability is assigned. A simple event is a single element of the sample space S, such as the event “both coins are tails” TT, or an event can be a larger subset of S, such as the event “at least one coin toss is tails” comprising the three simple events HT, HT, and TT.

The probability of an event E, denoted by P(E), satisfies the condition 0≦P(E)≦1 and is the sum of the probabilities associated with the simple events comprising the event E. For example, the probability of observing each of the simple events of the set S, representing the outcomes of tossing a fair coin two times, is ¼. The probability of the event “at least one coin is heads” is ¾(i.e., ¼+¼+¼), which are the probabilities of the simple events HH, HT, and TH, respectively).

Bayes' Theorem provides a formula for calculating conditional probabilities. A conditional probability is the probability of the occurrence of some event A, based on the occurrence of a different event B. Conditional probability can be defined by the following equation:

$$P ( A \vert B ) = \frac{P ( A ⋂ B )}{P ( B )}$$

where P(A|B) is read as “the probability of the event A, given the occurrence of the event B,”

P(A∩B) is read as “the probability of the events A and B both occurring,” and

P(B) is simple the probability of the event B occurring regardless of whether or not the event A occurs.

For an example of conditional probabilities, consider a club with four male and five female charter members that elects two women and three men to membership. See also, Goldberg, S., 1986, “Probability: An Introduction” by Samuel Goldberg,” pages 74-75. From the total of 14 members, one person is selected at random, and suppose it is known that the person selected is a charter member. Now consider the question of what is the probability the person selected is male? In other words, given that we already know the person selected is a charter member, what is the probability the person selected at random is male? In terms of the conditional probability, B is the event “the person selected is a charter member,” and A is the event “the person selected is male.” According to the formula for conditional probability:

P(B)= 9/14,and

P(A∩B)= 7/14

Thus, the probability of the person selected at random is male given that the person selected is a charter member is:

$$P ( A \vert B ) = \frac{( A ⋂ B )}{P ( B )} = \frac{7 / 14}{9 / 14} = \frac{7}{9}$$

Bayes' theorem relates the conditional probability of the event A given the event B to the probability of the event B given the event A. In other words, Bayes' theorem relates the conditional probabilities P(A|B) and (B|A) in a single mathematical expression as follows:

$$P ( A \vert B ) = \frac{P ( B \vert A ) P ( A )}{P ( B )}$$

P(A) is a prior probability of the event A. It is called the “prior” because it does not take into account the occurrence of the event B. P(B|A) is the conditional probability of observing the event B given the observation of the event A. P(A|B) is the conditional probability of observing the event A given the observation of the event B. It is called the “posterior” because it depends from, or is observed after, the occurrence of the event B. P(B) is a prior probability of the event B, and can serve as a normalizing constant.

For an example application of Bayes' theorem consider two urns containing colored balls as specified in Table I:

TABLE I

| Urn | Red | Yellow | Blue |
|---|---|---|---|
| 1 | 3 | 4 | 2 |
| 2 | 1 | 2 | 3 |

Suppose one of the urns is selected at random and a blue ball removed Bayes' theorem can be used to determine the probability the ball came from urn 1. Let B denote the event “ball selected is blue.” To account for the occurrence of B there are two hypotheses: A₁ is the event urn 1 is selected, and A₂ is the event urn 2 is selected.

Because the urn is selected at random,

P(A₁)=P(A₂)=½

Based on the entries in Table I, conditional probabilities also give:

P(B|A₁)= 2/9,and

P(B|A₂)= 3/6

The probability of the event “ball selected is blue,” regardless of which urn is selected, is

$$\begin{matrix}P ( B ) = P ( B \vert {A}_{1} ) P ( {A}_{1} ) + P ( B \vert {A}_{2} ) P ( {A}_{2} ) \\ = ( 2 / 9 ) ( 1 / 2 ) + ( 3 / 6 ) ( 1 / 2 ) \\ = ( 13 / 27 )\end{matrix}$$

Thus, according to Bayes' theorem, the probability the blue ball came from urn I is given by:

$$P ( {A}_{i} \vert B ) = \frac{P ( B \vert {A}_{1} ) P ( {A}_{1} )}{P ( B )} = \frac{( 2 / 9 ) ( 1 / 2 )}{13 / 27} = \frac{3}{13}$$

### Template Parameters

In this subsection, template parameters used to obtain dimensions of image fields and white spaces of a document template are described with reference to just three example document templates. The three examples described below are not intended to be exhaustive of the nearly limitless possible dimensions and arrangements of template elements. Instead, the examples described in this subsection are intended to merely provide a basic understanding of how the dimensions of elements of a template can be characterized, and are intended to introduce the reader to the terminology and notation used to represent template parameters and dimensions of document templates. Note that template parameters are not used to change the dimensions of the text fields or the overall dimensions of the templates. Template parameters are formally determined using probabilistic methods and systems described below in the subsequent subsection.

In preparing a document layout, document designers typically select a style sheet in order to determine the document's overall appearance. The style sheet may include (1) a typeface, character size, and colors for headings, text, and background; (2) format for how front matter, such as preface, figure list, and title page should appear; (3) format for how sections can be arranged in terms of space and number of columns, line spacing, margin widths on all sides, and spacing between headings just to name a few; and (4) any boilerplate content included on certain pages, such as copyright statements. The style sheet typically applies to the entire document. As necessary, specific elements of the style sheet may be overridden for particular sections of the document.

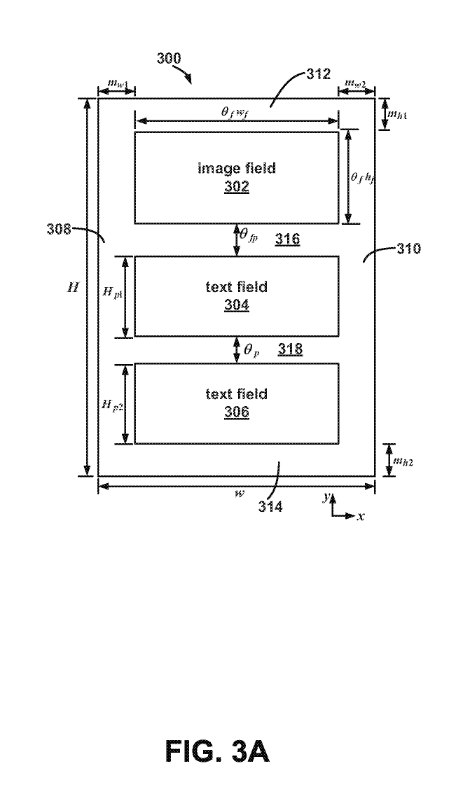

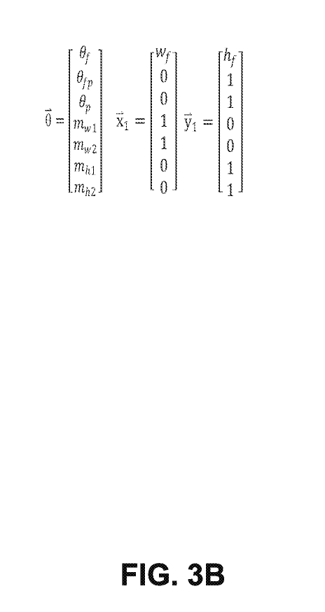

Document templates represent the arrangement elements for displaying text and images for each page of the document. FIG. 3A shows an example representation of a first single page template 300 with dimensions identified. Template 300 includes an image field 302, a first text field 304, and a second text field 306. The width and height of the template 300 are fixed values represented by constants W and H, respectively. Widths of margins 308 and 310, and m_{w1} and m_{w2}, extending in the y-direction are variable, and widths of top and bottom margins 312 and 314, mₕ₁ and mₕ₂, extending in the x-direction are variable. Note that templates may include a constraint on the minimum margin width below which the margins cannot be reduced. The dimensions of text fields 304 and 306 are also fixed with the heights denoted by Hₚ₁ and Hₚ₂, respectively. As shown in the example of FIG. 3A, the scaled height and width dimensions of an image placed in the image field 302 are represented by Θ_{f}h_{f} and Θ_{f}w_{f} respectively, where h_{f} and w_{f} represent the height and width of the image, and Θ_{f} is a single template parameter used to scale both the height h_{f} and width w_{f} of the image. Note that using a single scale factor Θ_{f} to adjust both the height and width of an image reduces image distortion, which is normally associated with adjusting the aspect ratio of an image in order to fit the image within an image field. FIG. 3A also includes a template parameter Θ_{fp} that scales the width of the white space 316, and a template parameter Θₚ that scales the width of the white space 318.

The template parameters and dimensions of an image and white space associated with the template 300 can be characterized by vectors as illustrated in FIG. 3B. The parameter vector [symbol] includes three template parameters Θ_{f}, Θ_{fp}, and Θₚ associated with adjusting the dimensions of the image field 302 and the white spaces 316 and 318 and includes the variable margin values m_{w1}, m_{w2}, mₕ₁ and mₕ₂. Vector elements of vector [symbol] ₁ represent dimensions of the image displayed in the image field 302 and margins in the x-direction, and vector elements of vector [symbol] ₁ represent dimensions of the image, white spaces, and margins in the y-direction. The vector elements of the vectors [symbol] ₁ and [symbol] ₁ are selected to correspond to the template parameters of the parameter vector [symbol] as follows.

Because both the width w_{f} and the height h_{f} of the image are scaled by the same parameter Θ_{f} as described above, the first vector elements of [symbol] ₁ and [symbol] ₁ are w_{f} and h_{f}, respectively. The other dimensions varied in the template 300 are the widths of the white spaces 316 and 318, which are varied in the y-direction, and the margins which are varied in the x- and y-directions. For [symbol] ₁ the two vector elements corresponding to the parameters Θ_{fp} and Θₚ are “0”, the two vector elements corresponding to the margins m_{w1} and m_{w2} are “1”, and the two vector elements corresponding to the margins mₕ₁ and mₕ₂ are “0”. For [symbol] ₁ the two vector elements corresponding to the parameters Θ_{fp} and Θₚ are “1”, the two vector elements corresponding to the margins m_{w1} and m_{w2} are “0” and the two vector elements corresponding to the margins mₕ₁ and mₕ₂ are “1”.

The vector elements of [symbol] ₁ and [symbol] ₁ are arranged to correspond to the parameters of the vector [symbol] in order to satisfy the following condition in the x-direction:

[symbol]

₁−W₁≈0

and the following condition in the y-direction:

[symbol]

₁−H₁≈0

where

[symbol] ₁=Θ_{f}w_{f}+m_{w1}+m_{w2} is the scaled width of the image displayed in the image field 302;

W₁=W is a variable corresponding to the space available to the image displayed in the image field 302 in the x-direction;

[symbol] ₁=Θ_{f}h_{f}+Θ_{fp}+Θₚ+mₕ₁+mₕ₂ is the sum of the scaled height of the image displayed in the image field 302 and the parameters associated with scaling the white spaces 316 and 318; and

H₁=H−Hₚ₁−Hₚ₂ is a variable corresponding to the space available for the image displayed in the image field 302 and the widths of the white spaces 316 and 318 in the y-direction.

Probabilistic methods based on Bayes' theorem described below can be used to determine the template parameters so that the conditions [symbol] ₁−W₁≈0 and [symbol] ₁−H₁≈0 are satisfied.

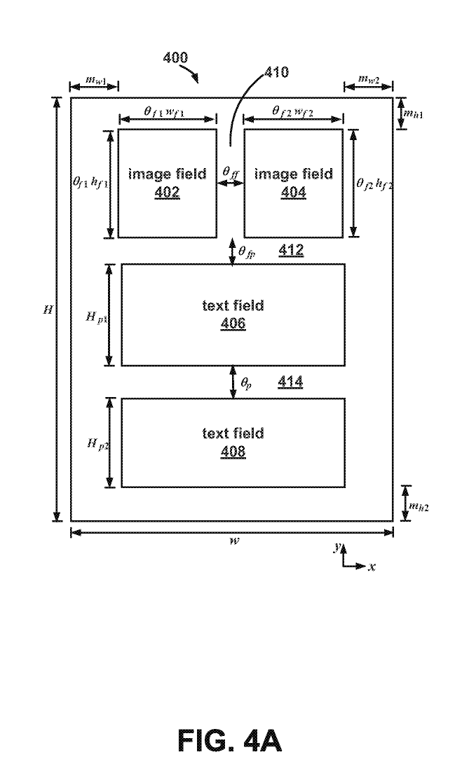

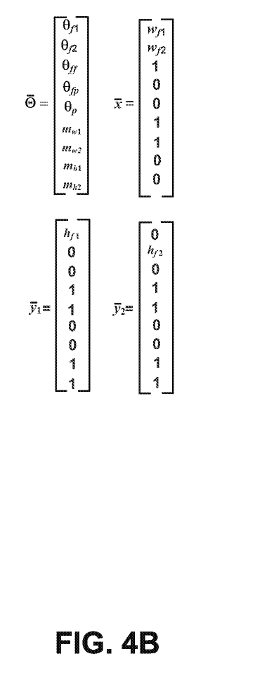

FIG. 4A shows an example representation of a second single page template 400 with dimensions identified. Template 400 includes a first image field 402, a second image field 404, a first text field 406, and a second text field 408. Like the template 300 described above, the template 400 width W and height H are fixed and side margins and m_{w2} extending in the y-direction and top and bottom margins mₕ₁ and mₕ₂ extending in the x-direction are variable but are subject to minimum value constraints. The dimensions of text fields 404 and 406 are also fixed with the heights denoted by Hₚ₁ and Hₚ₂, respectively. As shown in the example of FIG. 4A, the scaled height and width dimensions of an image placed in the image field 402 are represented by Θ_{f1}h_{f1} and Θ_{f1}w_{f1}, respectively, where h_{f1} and w_{f1} represent the height and width of the image, and Θ_{f1} is a single template parameter used to scale both the height h_{f1} and width w_{f1} of the image. The scaled height and width dimensions of an image displayed in the image field 404 are represented by Θ_{f2}h_{f2} and Θ_{f2}w_{f2} respectively, where h_{f2} and w_{f2} represent the height and width of the image, and Θ_{f2} is a single template parameter used to scale both the height h_{f2} and width w_{f2} of the image. FIG. 4A also includes a template parameter that scales the width of the white space 410, a template parameter Θ_{fp} that scales the width of the white space 412, and a template parameter Θₚ that scales the width of the white space 414.

The template parameters and dimensions of images and white spaces associated with the template 400 can be characterized by vectors as illustrated in FIG. 4B. The parameter vector [symbol] includes the five template parameters Θ_{f1}, Θ_{f2}, Θ_{ff}, Θ_{fp}, and Θₚ and the variable margin values m_{w1}, m_{w2}, mₕ₁, and mₕ₂. The changes to the template 400 in the x-direction are the widths of the images displayed in the image fields 402 and 404 and the width of the white space 410, which are characterized by a single vector [symbol] ₁. As shown in FIG. 4B, the first two vector elements of [symbol] ₁ are the widths w_{f1} and w_{f2} of the images displayed in the image fields 402 and 404 in the x-direction and correspond to the first two vector elements of the parameter vector [symbol] . The third vector element of [symbol] ₁ is “1” which accounts for the width of the white space 410 and corresponds to the third vector element of the parameter vector [symbol] . The fourth and fifth vector elements of [symbol] ₁ are “0” which correspond to the fourth and fifth the vector elements of [symbol] . The remaining four vector elements of [symbol] ₁ corresponding to the margins m_{w1} and m_{w2} are “1” and corresponding to the margins mₕ₁ and mₕ₂ are “0”.

On the other hand, changes to the template 400 in the y-direction are characterized by two vectors [symbol] ₁ and [symbol] ₂ each vector accounting for changes in the height of two different images displayed in the image fields 402 and 404 and the white spaces 412 and 414. As shown in FIG. 4B, the first vector element of [symbol] ₁ is the height of the image displayed in the image field 402 and corresponds to the first vector element of the parameter vector [symbol] . The second vector element of [symbol] ₂ is the height of the image displayed in the image field 404 and corresponds to the second term of the parameter vector [symbol] . The fourth and fifth vector elements of [symbol] ₁ and [symbol] ₂ are “1” which account for the widths of the white spaces 412 and 414 and correspond to the fourth and fifth vector elements of the parameter vector [symbol] . The “0” vector elements of [symbol] ₁ and [symbol] ₂ correspond to the parameters that scale dimensions in the x-direction. The remaining four vector elements of [symbol] ₁ and [symbol] ₂ and corresponding to the margins m_{w1} and m_{w2} are “0” and corresponding to the margins mₕ₁ and mₕ₂ are “1”.

As described above with reference to FIG. 4B, the vector elements of [symbol] ₁, [symbol] ₁ and [symbol] ₂ are arranged to correspond to the parameters of the vector [symbol] to satisfy the following condition in the x-direction:

[symbol]

₁−W₁≈0

and the following conditions in the y-direction:

[symbol]

₁−H₁≈0

[symbol]

₂−H₂≈0

where

[symbol] ₁=Θ_{f1}w_{f1}+Θ_{f2}w_{f2}+Θ_{ff}+m_{w1}+m_{w2} is the scaled width of the images displayed in the image fields 402 and 404 and the width of the white space 410;

W₁=W is a variable corresponding to the space available for the images displayed in the image fields 402 and 404 and the white space 410 in the x-direction;

[symbol] ₁=Θ_{f1}h_{f1}+Θ_{fp}+Θₚ+mₕ₁+mₕ₂ is the sum of the scaled height of the image displayed in the image field 402 and the parameters associated with scaling the white spaces 412 and 414;

[symbol] ₂=Θ_{f2}h_{f2}+Θ_{fp}+Θₚ+mₕ₁+mₕ₂ is the sum of the scaled height of the image displayed in the image field 404 and the parameters associated with scaling the white spaces 412 and 414,

H₁=H−Hₚ₁−Hₚ₂ is a first variable corresponding to the space available for the image displayed in the image field 402 and the widths of the white spaces 412 and 414 in the y-direction; and

H₂=H₁ is a second constant corresponding to the space available for the image displayed in the image field 404 and the widths of the white spaces 412 and 414 in the y-direction.

Probabilistic methods based on Bayes' theorem described below can be used to determine the template parameters so that the conditions [symbol] ₁−W₁≈0, [symbol] ₁−H₁≈0, and [symbol] ₂−H₂≈0 are satisfied.

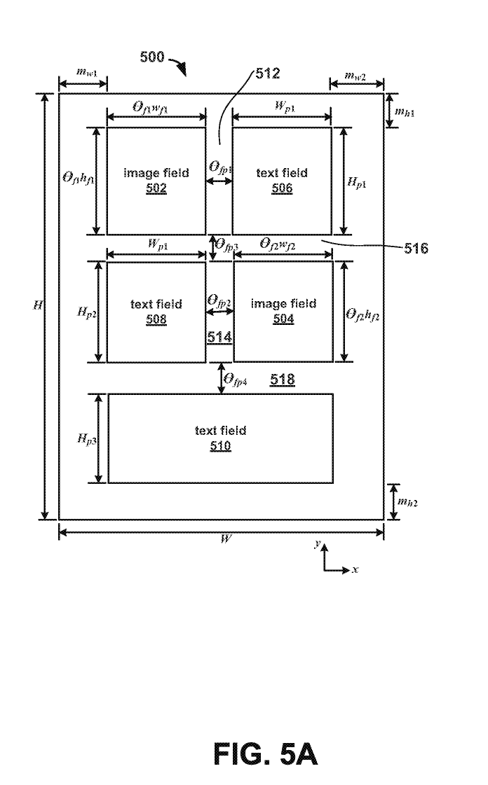

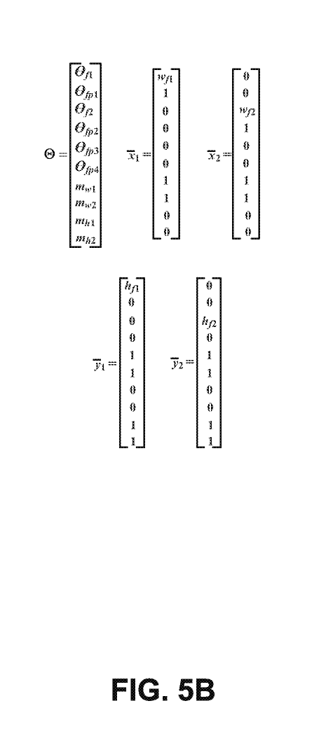

FIG. 5A shows an example representation of a single page template 500 with dimensions identified. Template 500 includes a first image field 502, a second image field 504, a first text field 506, a second text field 508, and a third text field 510. Like the templates 300 and 400 described above, the template width W and height H are fixed and side margins m_{w1} and m_{w2} extending in the y-direction and top and bottom margins mₕ₁ and mₕ₂ extending in the x-direction are variable, but are subject to minimum value constraints. The dimensions of text fields 506, 508, and 510 are also fixed with the heights denoted by Hₚ₁, Hₚ₂, and Hₚ₃, respectively, and the widths of the text fields 506 and 508 denoted by Wₚ₁ and Wₚ₂, respectively. As shown in the example of FIG. 5A, the scaled height and width dimensions of an image displayed in the image field 502 are represented by Θ_{f1}h_{f1} and Θ_{f1}w_{f1} respectively, where h_{f1} and w_{f1} represent the height and width of the image, and Θ_{f1} is a single template parameter used to scale both the height h_{f1} and width w_{f1} of the image. The scaled height and width dimensions of an image displayed in the image field 504 are represented by Θ_{f2}h_{f2} and Θ_{f2}w_{f2} respectively, where h_{f2} and w_{f2} represent the height and width of the image, and Θ_{f2} is a single template parameter used to scale both the height h_{f2} and width w_{f2} of the image. FIG. 5A also includes a template parameter Θ_{fp1} that scales the width of the white space 512, a template parameter Θ_{fp2} that scales the width of the white space 514, a template parameter Θ_{fp3} that scales the width of the white space 516, and a template parameter Θ_{fp4} that scales the width of white space 518.

The template parameters and dimensions of images and white spaces associated with the template 500 can be characterized by vectors as illustrated in FIG. 5B. The parameter vector [symbol] includes the six template parameters Θ_{f1}, Θ_{fp1}, Θ_{f2}, Θ_{fp2}, Θ_{fp3}, and Θ_{fp4} and the variable margin values m_{w1}, m_{w2}, mₕ₁, and mₕ₂. The changes to the template 500 in the x-direction include the width of the image displayed in the image field 502 and the width of the white space 512, and separate changes in the width of the image displayed in the image field 504 and the width of the white space 514. These changes are characterized by vectors [symbol] ₁ and [symbol] ₂. As shown in FIG. 5B, the first vector element of [symbol] ₁ is the width w_{f1} and the second vector element is “1” which correspond to first two vector elements of the parameter vector [symbol] . The third vector element of [symbol] ₂ is the width w_{f2} and the fourth vector element is “1” which correspond to first third and fourth vector elements of the parameter vector [symbol] . The fifth and sixth vector elements of [symbol] ₁ and [symbol] ₂ corresponding to white spaces that scale dimensions in the y-direction are “0”. The remaining four vector elements of [symbol] ₁ and [symbol] ₂ corresponding to the margins m_{w1} and m_{w2} are “1” and corresponding to the margins mₕ₁ and mₕ₂ are “0”

On the other hand, changes to the template 500 in the y-direction are also characterized by two vectors [symbol] ₁ and [symbol] ₂. As shown in FIG. 5B, the first vector element of [symbol] ₁ is the height of the image displayed in the image field 502 and corresponds to the first vector element of the parameter vector [symbol] . The third vector element of [symbol] ₂ is the height of the image displayed in the image field 504 and corresponds to the third term of the parameter vector [symbol] . The fifth and sixth vector elements of [symbol] ₁ and [symbol] ₂ are “1” which account for the widths of the white spaces 516 and 518 and correspond to the fifth and sixth vector elements of the parameter vector [symbol] . The vector elements of [symbol] ₁ and [symbol] ₂ corresponding to white space that scale in the x-direction are “0”. The remaining four vector elements of [symbol] ₁ and [symbol] ₂ corresponding to the margins m_{w1} and m_{w2} are “0” and corresponding to the margins mₕ₁ and mₕ₂ are “1”.

As described above with reference to FIG. 5B, the vector elements of [symbol] ₁, [symbol] ₂, [symbol] ₁, and [symbol] ₂ are arranged to correspond to the parameters of the vector [symbol] in order to satisfy the following conditions in the x-direction:

[symbol]

₁−W₁≈0

[symbol]

₂−W₂≈0

and satisfy the following conditions in the y-direction:

[symbol]

₁−H₁≈0

[symbol]

₂−H₂≈00

where

[symbol] ₁=Θ_{f1}w_{f1}+Θ_{fp1}+m_{w1}+m_{w2} is the scaled width of the images displayed in the image fields 502 and the width of the white space 512;

W₁=W−Wₚ₁ is a first variable corresponding to the space available for displaying an image into the image field 502 and the width of the white space 512 in the x-direction;

[symbol] ₂=Θ_{f2}w_{f2}+Θ_{fp2}+m_{w1}+m_{w2} is the sealed width of the image displayed in the image field 501 and the width of the white space 514;

W₂=W−Wₚ₂ is a second variable corresponding to the space available for displaying an image into the image field 504 and width of the white space 514 in the x-direction;

[symbol] ₁=Θ_{f1}h_{f1}+Θ_{fp3}+Θ_{fp4}+mₕ₁+mₕ₂ is the sum of the scaled height of the image displayed in the image field 402 and the parameters associated with scaling the white spaces 412 and 414;

H₁=H−Hₚ₂−Hₚ₃ is a first constant corresponding to the space available to the height of the image displayed in image field 502 and the widths of the white spaces 516 and 518 in the y-direction;

[symbol] ₂=Θ_{f2}h_{f2}+Θ_{fp3}+Θ_{fp4}+mₕ₁+mₕ₂ is the sum of the scaled height of the image displayed in the image field 404 and the parameters associated with scaling the white spaces 412 and 414; and

H₂=H−Hₚ₁−Hₚ₃ is a second constant corresponding to the space available to the height of the image displayed in image field 504 and the widths of the white spaces 516 and 518 in the y-direction.

Probabilistic methods based on Bayes' theorem described below can be used to determine the template parameters so that the conditions [symbol] ₁−W₁≈0, [symbol] ₂−W₂≈0, [symbol] ₁−H₁≈0, and [symbol] ₂−H₂≈0 are satisfied.

Note that the templates 300, 400, and 500 are examples representing how the number of constants associated with the space available in the x-direction Wᵢ and corresponding vectors [symbol] ᵢ, and the number of constants associated with the space available in the y-direction Hⱼ and corresponding vectors [symbol] ⱼ, can be determined by the number of image fields and how the image fields are arranged within the template. For example, for the template 300, shown in FIGS. 3A-3B, the template 300 is configured with a single image field resulting in a single constant W₁ and corresponding vector [symbol] ₁ and a single constant H₁ and corresponding vector [symbol] ₁. However, when the number of image fields exceeds one, the arrangement of image fields can create more than one row and/or column, and thus, the number of constants representing the space available in the x- and y-directions can be different, depending on how the image fields are arranged. For example, for the template 400, shown in FIG. 4A-4B, the image fields 402 and 404 create a single row in the x-direction no that the space available for adjusting the images placed in the image fields 402 and 404 in the x-direction can be accounted for with a single constant and the widths of the images and white space 410 can be accounted for in a single associated vector [symbol] ₁.

On the other hand, as shown in FIG. 4A, the image fields 402 and 404 also create two different columns in the y-direction. Thus, the space available for separately adjusting the images placed in the image fields 402 and 404 in the y-direction can be accounted for with two different constants H₁ and H₂ and associated vectors [symbol] ₁ and [symbol] ₂. The template 500, shown in FIGS. 5A-5B, represents a case where the image fields 502 and 504 create two different rows in the x-direction and two different columns in the y-direction. Thus, in the x-direction, the space available for separately adjusting the images placed in the image fields 502 and 504 and the white spaces 512 and 514 can be accounted for with two different constants W₁ and W₂ and associated vectors [symbol] ₁ and [symbol] ₂ and in the y-direction, the space available for separately adjusting the same images and the white spaces 516 and 516 can be accounted for with two different constants H₁ and H₂ and associated vectors [symbol] ₁ and [symbol] ₂.

In summary, a template is defined for a given number of images. In particular, for a template configured with m rows and n columns of image fields, there are W₁, W₂, . . . Wₘ constants and corresponding vectors [symbol] ₁, [symbol] ₂, . . . [symbol] ₘ associated with the m rows, and there are H₁, H₂, . . . Hₙ constants and corresponding vectors [symbol] ₁, [symbol] ₂, . . . [symbol] ₙ associated with the n columns.

### Probabilistic Optimizing Document Layout

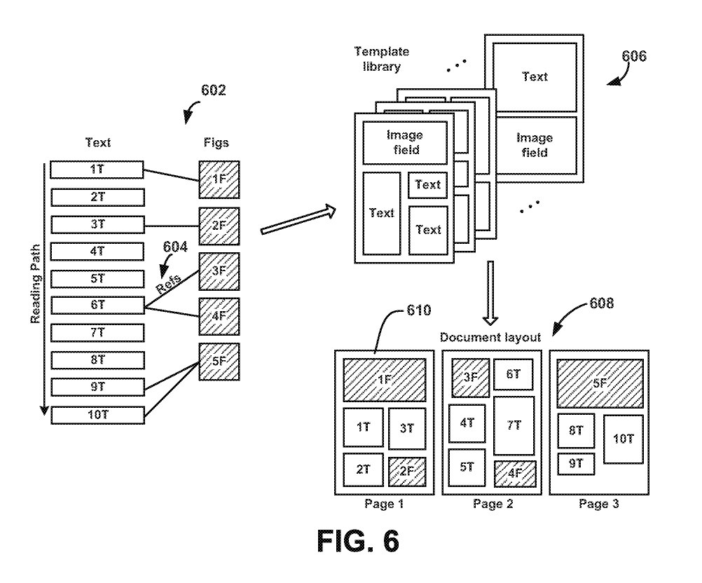

FIG. 6 and the accompanying description are intended to introduce terminology and provide a general overview of the operations performed by one example.

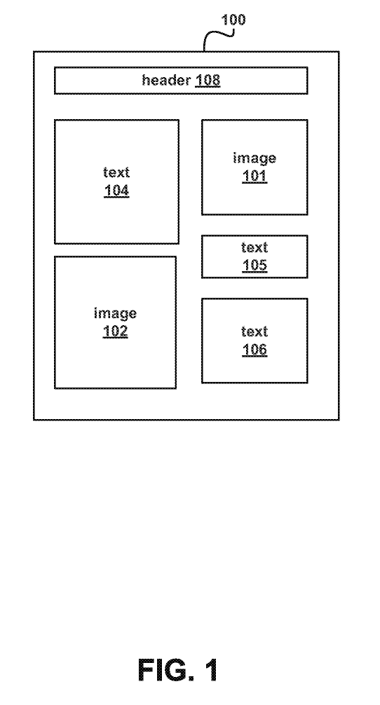

FIG. 6 shows an example of generating an optimized document layout from raw input. Raw input 602 comprises text, figures, references, and semantic information. The text portion of the raw input 602 is represented by rectangular blocks labeled 1T-10T, each block representing text such as one or more paragraphs or a heading, and the figures portion of the raw input 602 is represented by squares labeled 1F-5F, each square representing a figure. The raw input 602 also includes semantic information represented by lines extending between text blocks and figures. Semantic information can include which text blocks correspond to headings and which text blocks reference figures. For example, text block 1T makes reference to FIG. 1F and text blocks 9T and 10T make reference to FIG. 5F. Semantic information also identifies which text blocks and figures are associated with a reference. For example, reference 604 corresponds to text block 6T and FIG. 3F. Note the raw input does not include which text, figures, and references are to be selected for each page or how text, figures, and references are to be arranged on each page of the overall document.

Examples determine an allocation of text, figures, and references for each page of the document. An allocation corresponds to the number of lines of text n_{L} and the number of figures n_{F} assigned to a page. Each page allocation is characterized by a random variable Aⱼ, where j is a non-negative integer used to identify a page of the document. For the first page of the document j equals “0.” A random variable is a function whose domain is a sample space and whose range is a set of real numbers. For example, referring to FIG. 6, an example of a sample space corresponding to the first page of the document can be the set:

S₀={[1T;1F],[1T,2T;1F],[1T,2T,3T;1F,2F],[1T,2T,3T,4T;1F,2F]}

where each element in S₀ is a bracket listing text blocks and figures that can be allocated to the first page of the document. The random variable A₀ assigns a real value to each element in S₀. Allocations for pages 2 through P+1 are denoted by A₁ through Aₚ, respectively, and are similarly defined with an allocation for a subsequent page dependent upon the allocation for the previous page. Method and system examples described below determine optimal allocations A₀*, A₁*, . . . , Aₚ* for each page. For example, the optimal allocation A₀* for page 1 can be the sample space element [1T, 2T, 3T; 1F, 2F].

Returning to FIG. 6, once the optimal allocations are determined for the document, method and system examples determine an optimal template for each optimal allocation. FIG. 6 shows an example of a template library 606 stored in a computer readable medium. Suppose the optimal allocation A₀* for page 1 is [1T, 2T, 3T; 1F, 2F]. There may be a number of templates in the template library 606 that can accommodate the text and figures associated with the optical allocation A₀*. These templates form a sample space of a template random variable T₀ associated with the first page. Template random variables T₁, . . . , T_{P} associated with allocations for pages 2 through P+1 are similarly defined, with the sample space of each template random variable Tⱼ corresponding to a subset of templates in the template library 606. Method and system examples described below determine the optimal template for each of the optimal allocations.

Once an optimal template is determined for each page of the document, an optimal set of template parameters [symbol] ⱼ associated with dimensioning and spacing template elements is determined as described below, and each page of the document is rendered. For example, returning to FIG. 6 reveals an example of a final document layout 608 for the raw input 602, hypothetically generated by one example. The document layout comprises three pages. Page 1 has the optimal allocation [1T, 2T, 3T; 1F, 2F] and an optimal template selected from the template library 608 with optimal figure and white space parameters [symbol] ₀. Subsequent pages 2 and 3 also correspond to optimal allocations, templates, and parameters.

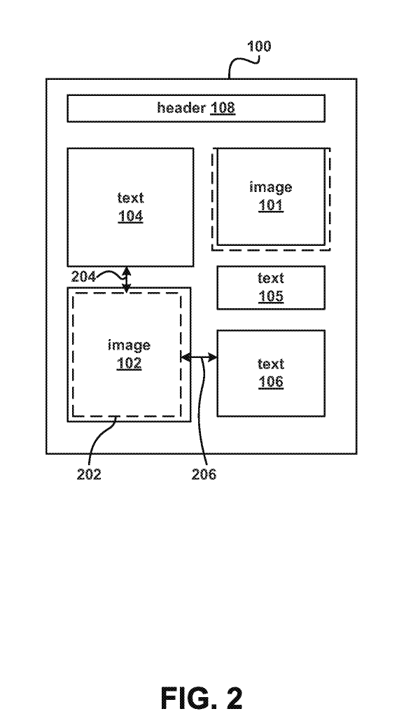

Note that with the exception of the first page, allocations for subsequent pages depend on the allocation for the previous page. For example, consider once again the example allocation of text blocks and figures for the first page, [1T, 2T, 3T; 1F, 2F]. The allocation for the second page cannot also include text blocks 1T, 2T, 3T and FIGS. 1F and 2F, because these text blocks and figures have already been assigned to the first page.

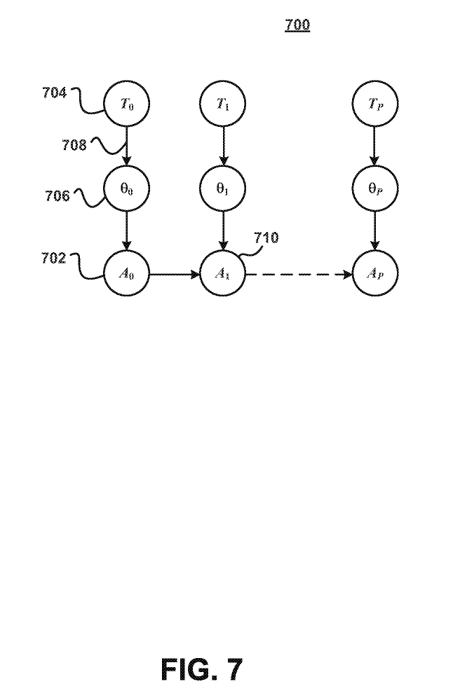

The relationships between allocations, templates, and parameters can be represented by a Bayesian network. FIG. 7 shows an example Bayesian network 700 characterizing conditional independencies of the random variables associated with allocations Aⱼ, templates Tⱼ, and parameters [symbol] ⱼ. Each node of the Bayesian network 700 represents a random variable corresponding to events in a sample space. For example, node 702 represents a random variable A₀ associated with a sample space of allocations for the first page, node 704 represents a random variable T₀ associated with a sample space of templates for the allocation selected for the first page, and node 706 represents the random variable vector [symbol] ₀ associated with a sample space of parameters for the template selected for the first page. Directional arrows in the Bayesian network independently identify conditional probabilities between nodes. For example, directional arrow 708 represents the conditional probability P( [symbol] ₀|T₀) for a set of parameters [symbol] ₀ given a template T₀, but the allocations A₁, . . . , A_{P} have more than one parent node. Thus, the conditional probability for the node 710 representing the allocation A₁ is P(A₁|A₀, [symbol] ₁).

Note that the Bayesian network defines a conditional independency structure. In other words, any node is conditionally independent of its non-descendent given its parent. For nodes like T₀, . . . , T_{P} the probabilities associated with these nodes P(T₀), . . . , P(T₀) are not conditioned on any other nodes.

A joint probability distribution that characterizes the conditional probabilities of a Bayesian network is a product of the probabilities of the parent nodes and the conditional probabilities. Thus, the joint probability distribution associated with the Bayesian network 700 is given by:

$$P ( \{ {T}_{j} \} , \{ {\vec{Θ}}_{j} \} , \{ {A}_{j} \} ) = P ( {A}_{0} \vert {\vec{Θ}}_{0} ) P ( {\vec{Θ}}_{0} \vert {T}_{0} ) P ( {T}_{0} ) \times {\prod }_{i = 1}^{P} P ( {A}_{j} \vert {A}_{j - 1} , {\vec{Θ}}_{j} ) P ( {\vec{Θ}}_{j} \vert {T}_{j} ) P ( {T}_{j} )$$

As shown in FIG. 7, allocution A₀ for the first page “0” is independent, but allocations for each of the subsequent pages depend on the allocation for the previous page. Thus, P({Tⱼ}, { [symbol] ⱼ}, {Aⱼ}) includes the terms P(Aⱼ|Aⱼ₋₁, [symbol] ⱼ).

One example is predicated on maximizing P({Tⱼ}, { [symbol] ⱼ}, {Aⱼ}) with the assumption that the larger the probability P({Tⱼ}, { [symbol] ⱼ}, {Aⱼ}), the close the document layout is to having the following desired document properties:

(1) each page of the document should look as good as possible to achieve overall optimal layout quality;

(2) text blocks that reference figures and the corresponding figures should appear on the same page; and

(3) the total number of pages is minimized.

In order to determine the sets {Tⱼ}, { [symbol] ⱼ}, and {Aⱼ} for a document that gives the maximum probability P({Tⱼ}, { [symbol] ⱼ}, {Aⱼ}), a maximum joint probability distribution is defined as follows:

$$\begin{matrix}{P}^{*} ( \{ {T}_{j} \} , \{ {\vec{Θ}}_{j} \} , \{ {A}_{j} \} ) = {max}_{\{ {A}_{j} \}} φ ( {A}_{0} ) {\prod }_{j = 1}^{P} φ ( {A}_{j} , {A}_{j - 1} ) & Equations ( 1 ) \\ φ ( {A}_{j} , {A}_{j - 1} ) = {max}_{{T}_{j}} ψ ( {A}_{j} , {A}_{j - 1} , {T}_{j} ) P ( {T}_{j} ) & Equations ( 2 ) \\ ψ ( {A}_{j} , {A}_{j - 1} , {T}_{j} ) = {max}_{{\vec{Θ}}_{j}} P ( {A}_{j} \vert {A}_{j - 1} , {\vec{Θ}}_{j} ) P ( {\vec{Θ}}_{j} \vert {T}_{j} ) & Equations ( 3 )\end{matrix}$$

Equations (1), (2), and (3) are used to determined optimal allocations, templates, and template parameters using the method of “belief propagation” from Bayesian methods. For the sake of simplicity, a description of determining the set {Aⱼ} of optimal allocations using belief propagation is described first, followed by a description of determining an optimal template for each optimal allocation, and finally determining optimal template parameters for each template. However, in practice, optimal allocations, templates, and template parameters can also be determined simultaneously using belief propagation.

The set of allocations {Aⱼ} that maximize equation (1) can be obtained by first determining the φ's. Each φ is a function of random variables, and is the maximum of a sequence of real numbers, one for each template Tⱼ, as described in equation (2). Hence for each Aⱼ and Aⱼ₋₁ there is a maximizing template tⱼ*. For the first page, φ(A₀) is the maximum of the range of real values associated with the allocation A₀. For subsequent pages, φ(Aⱼ, Aⱼ₋₁) is the maximum of the range of real values associated with the allocations Aⱼ and Aⱼ₋₁.

Once the φ's have been determined, a set of recursive equations denoted by τ are used to determined the optimal allocations A₀*, A₁*, . . . , Aₚ*. First, each τ is computed recursively as follows:

$${τ}_{1} ( {A}_{1} ) = {max}_{{A}_{0}} φ ( {A}_{0} ) φ ( {A}_{1} , {A}_{0} )$$

$${τ}_{j} ( {A}_{j} ) = {max}_{{A}_{j - 1}} {τ}_{j - 1} ( {A}_{j - 1} ) φ ( {A}_{j} , {A}_{j - 1} ) , and$$

$${τ}_{P + 1} ( {A}_{1} ) = {max}_{{A}_{p}} {τ}_{p} ( {A}_{p} )$$

Next, after each of the τⱼ's have been recursively obtained, optimal allocations A₀*, A₁*, . . . , Aₚ* can be obtained by solving the τⱼ's in a reverse recursive manner as follows:

$${A}_{p}^{*} = {arg max}_{{A}_{p}} {τ}_{p} ( {A}_{p} ) , and$$

$${A}_{j - 1}^{*} = {arg max}_{{A}_{j - 1}} {τ}_{j - 1} ( {A}_{j - 1} ) φ ( {A}_{j}^{*} , {A}_{j - 1} )$$

Thus, optimal allocations A₀*, A₁*, . . . , Aₚ* for maximizing the probability P*({Tⱼ}, { [symbol] ⱼ}, {Aⱼ}) have been determined.

After the set of optimal allocations have been determined, for each optimal allocation, equations (2) and (3) can be used to determine an optimal Tⱼ and [symbol] ⱼ. For each Aⱼ there is a set of Tⱼ's. Once a φ(Aⱼ, Aⱼ₋₁) is determined, the corresponding Tⱼ maximizes equation (2) and the corresponding template parameters [symbol] ⱼ maximize equation (3). In equation (3), P(Aⱼ|Aⱼ₋₁, [symbol] ⱼ) is the product of layout quality, reference quality, and page qualities probabilities given by:

P(Aⱼ|Aⱼ₋₁, [symbol] ⱼ)=P_{Q}(Aⱼ|Aⱼ₋₁, [symbol] ⱼ)P_{R}(Aⱼ|Aⱼ₋₁)P_{P}(Aⱼ|Aⱼ₋₁)

The conditional probability P_{Q}(Aⱼ|Aⱼ₋₁, [symbol] ⱼ) associated with layout quality is determined by a document designer. The reference quality probability can be defined as follows:

P_{R}(Aⱼ|Aⱼ₋₁)∝ exp {−γ|R_{A}_{ⱼ}_{,A}_{ⱼ₋₁}|}

where γ is a reference constant assigned by the document designer, and |R_{A}_{ⱼ}_{,A}_{ⱼ₋₁}| corresponds to the number of misplaced references due to the previous allocation Aⱼ₋₁. The page quantity probability can be defined as follows:

P_{P}(Aⱼ|Aⱼ₋₁)∝ exp {−δ}

where δ is a page constant assigned by the document designer and corresponds to a page number penalty that is used to control the overall number of pages in the final document.

Next a closed form equation for determining the parameter vector [symbol] , for each template is now described. This closed form description can be obtained by considering the relationship between dimensions of elements of a template with m rows of image fields and n columns of image fields and the corresponding parameter vector [symbol] in terms of Bayes' Theorem from probability theory as follows:

P( [symbol] | [symbol] )∝P( [symbol] | [symbol] )P( [symbol] ) Equation (1)

where

[symbol]

=[W₁, W₂, . . . Wₘ]^{T},

[symbol]

=[H₁, H₂, . . . Hₙ]^{T},

[symbol]

=[ [symbol] ₁, [symbol] ₂, . . . [symbol] ₘ]^{T},

[symbol]

=[ [symbol] ₁, [symbol] ₂, . . . [symbol] ₙ]^{T},

the exponent T represents the transpose from matrix theory.

Vector notation is used to succinctly represent template constants Wᵢ and corresponding vectors [symbol] ᵢ associated with the m rows and template constants Hⱼ and corresponding vectors [symbol] ⱼ associated with the n columns of the template.

Equation (1) is in the form of Bayes' Theorem but with the normalizing probability P( [symbol] ) excluded from the denominator of the right-hand side of equation (1) (e.g., see the definition of Bayes' Theorem provided in the subsection titled An Overview of Bayes' Theorem and Related Concepts from Probability Theory). As demonstrated below, the normalizing probability P( [symbol] ) does not contribute to determining the template parameters [symbol] that maximize the posterior probability P( [symbol] | [symbol] ), and for this reason P( [symbol] ) can be excluded from the denominator of the right-hand side of equation (1).

In equation (1), the term P( [symbol] ) is the prior probability associated with the parameter vector [symbol] and does not take into account the occurrence of an event composed of [symbol] . In certain examples, the prior probability can be characterized by a normal, or Gaussian, probability distribution given by:

$$P ( \vec{Θ} ) \approx N ( \vec{Θ} \vert {\overline{Θ}}_{1} , {Λ}_{1}^{- 1} ) N ( \vec{Θ} \vert {\overline{Θ}}_{2} , {Λ}_{2}^{- 1} ) \\ ∝ exp ( {( {\overline{Θ}}_{1} - \vec{Θ} )}^{T} \frac{{Λ}_{1}}{2} ( {\overline{Θ}}_{1} - \vec{Θ} ) ) exp ( {( {\overline{Θ}}_{2} - \vec{Θ} )}^{T} \frac{{Λ}_{2}}{2} ( {\overline{Θ}}_{2} - \vec{Θ} ) )$$

where

Θ₁ is a vector composed of independent mean values for the parameters set by a document designer;

Λ₁ is a diagonal matrix of variances for the independent parameters set by the document designer;

Λ₂=C^{T}Δ^{T}ΔC is a non-diagonal covariance matrix for dependent parameters; and

Θ̅₂=Λ⁻¹C^{T}Δ^{T}Δ [symbol] is a vector composed of dependent mean values for the parameters.

The matrix C and the vector [symbol] characterize the linear relationships between the parameters of the parameter vector [symbol] given by C [symbol] = [symbol] and [symbol] is a covariance precision matrix. For example, consider the template 300 described above with reference to FIGS. 3A-3B. Suppose hypothetically the parameters of the parameter vector [symbol] represented in FIG. 3B are linearly related by the following equations:

0.2Θ_{f}+3.1Θₚ≈−1.4,and

1.8Θ_{f}−0.7Θₚ+1.1Θₚ≈−3.1

Thus, in matrix notation, these two equations can be represented as follows:

$$C \vec{Θ} = [ \begin{matrix}0.2 & 0 & 3.1 \\ 1.8 & - 0.7 & 1.1\end{matrix} ] [ \begin{matrix}{Θ}_{f} \\ {Θ}_{fp} \\ {Θ}_{p}\end{matrix} ] \approx [ \begin{matrix}- 1.4 \\ 3.1\end{matrix} ] = \vec{d}$$

Returning to equation (1), the term P( [symbol] | [symbol] ) is the conditional probability of an event composed of [symbol] , and [symbol] , given the occurrence of the parameters of the parameter vector Θ̅. In certain examples, the term P( [symbol] | [symbol] ) can be characterized as follows:

$$P ( \vec{W} , \vec{H} , \vec{x} , \vec{y} , \vert \vec{Θ} ) ∝ {\prod }_{i}^{ } {\prod }_{j}^{ } N ( {W}_{i} \vert {\vec{Θ}}^{T} {\vec{x}}_{i} , {α}_{i}^{- 1} ) N ( {H}_{j} \vert {\vec{Θ}}^{T} {\vec{y}}_{j} , {β}_{j}^{- 1} ) \\ where \\ N ( {W}_{i} \vert {\vec{Θ}}^{T} {\vec{x}}_{i} , {α}_{i}^{- 1} ) ∝ exp ( - \frac{{α}_{i}}{2} {( {\vec{Θ}}^{T} {\vec{x}}_{i} - {W}_{i} )}^{2} ) , and \\ N ( {H}_{j} \vert {\vec{Θ}}^{T} {\vec{y}}_{j} , {β}_{j}^{- 1} ) ∝ exp ( - \frac{{β}_{i}}{2} {( {\vec{Θ}}^{T} {\vec{y}}_{j} - {H}_{j} )}^{2} ) . \qquad Equation ( 2 )$$

are normal probability distributions. The variables αᵢ⁻¹ and βⱼ⁻¹ variances and Wᵢ and Hⱼ represent mean values for the distributions N(Wᵢ| [symbol] ᵢ, αᵢ⁻¹) and N(Hⱼ| [symbol] ⱼ, βⱼ⁻¹), respectively. Normal distributions can be used to characterize, at least approximately, the probability distribution of a variable that tends to cluster around the mean. In other words, variables close to the mean are more likely to occur than are variables farther from the mean. The normal distributions N(Wᵢ| [symbol] ᵢ, αᵢ⁻¹) and N(Hⱼ| [symbol] ⱼ, βⱼ⁻¹) characterize the probability distributions of the variables Wᵢ if and Hⱼ about the mean values [symbol] ᵢ and [symbol] ⱼ respectively.

For the sake of discussion, consider just the distribution N(Wᵢ| [symbol] ᵢ, αᵢ⁻¹). FIG. 6 shows example plots of N(Wᵢ| [symbol] ᵢ, αᵢ⁻¹) represented by curves 602-604, each curve representing the normal distribution N(Wᵢ| [symbol] ᵢ, αᵢ⁻¹) for three different values of the variance αᵢ⁻¹. Comparing curves 602-604 reveals that curve 602 has the smallest variance and the narrowest distribution about [symbol] curve 604 has the largest variance and the broadest distribution about [symbol] , and curve 603 has an intermediate variance and an intermediate distribution about [symbol] . In other words, the larger the variance αᵢ⁻¹ the broader the distribution N(Wᵢ| [symbol] ᵢ, αᵢ⁻¹) about [symbol] ᵢ, and the smaller the variance αᵢ⁻¹ the narrower the distribution N(Wᵢ| [symbol] ᵢ, αᵢ⁻¹) about [symbol] ᵢ. Note that all three curves 602-604 also have corresponding maxima 606-608 centered about [symbol] . Thus, when [symbol] ᵢ equals Wᵢ (i.e., [symbol] ᵢ−Wᵢ=0), the normal distribution N(Wᵢ| [symbol] ᵢ, αᵢ⁻¹) is at a maximum value. The same observations can also be made for the normal distribution N(Hⱼ| [symbol] ⱼ, βⱼ⁻¹).

The posterior probability P( [symbol] | [symbol] ) can be maximized when the exponents of the normal distributions of equation (2) satisfy the following conditions:

[symbol]

ᵢ−Wᵢ≈0 and [symbol] ⱼ−Hⱼ≈0

for all i and j. As described above, for a template, Wᵢ and Hⱼ are constants and the elements of [symbol] ᵢ and [symbol] ⱼ are constants. These conditions are satisfied by determining a parameter vector [symbol] ^{MAP} that maximizes the posterior probability P( [symbol] | [symbol] ). The parameter vector [symbol] ^{MAP} can be determined by rewriting the posterior probability P( [symbol] | [symbol] ) as a multi-variate normal distribution with a well characterized mean and variance as follows:

$$P ( \vec{Θ} \vert \vec{W} , \vec{H} , \vec{x} , \vec{y} ) = N ( \overline{Θ} \vert {\vec{Θ}}^{MAP} , {( Λ + {\sum }_{i} {α}_{i} {\vec{x}}_{i} {\vec{x}}_{i}^{T} + {\sum }_{j} {β}_{j} {\vec{y}}_{j} {\vec{y}}_{j}^{T} )}^{- 1} )$$

The parameter vector [symbol] ^{MAP} is the mean of the normal distribution characterization of the posterior probability P( [symbol] | [symbol] ), and [symbol] maximizes P( [symbol] | [symbol] ) when [symbol] equals [symbol] ^{MAP}. Solving P( [symbol] | [symbol] ) for [symbol] gives the following closed form expression:

$${\vec{Θ}}^{MAP} = {( Λ + {\sum }_{i} {α}_{i} {\vec{x}}_{i} {\vec{x}}_{i}^{T} + {\sum }_{j} {β}_{j} {\vec{y}}_{j} {\vec{y}}_{j}^{T} )}^{- 1} ( Λ \overline{Θ} + {\sum }_{i} {α}_{i} {W}_{i} {\vec{x}}_{i} + {\sum }_{j} {β}_{j} {H}_{j} {\vec{y}}_{j} )$$

The parameter vector [symbol] ^{MAP} can also be rewritten in matrix from as follows:

[symbol]

^{MAP}=A⁻¹

[symbol]

where

$$A = Λ + {\sum }_{i} {α}_{i} {\vec{x}}_{i} {\vec{x}}_{i}^{T} + {\sum }_{j} {β}_{j} {\vec{y}}_{j} {\vec{y}}_{j}^{T}$$

is a matrix and A⁻¹ is the inverse of A, and

$$\vec{b} = Λ \overline{Θ} + {\sum }_{i} {α}_{i} {W}_{i} {\vec{x}}_{i} + {\sum }_{j} {β}_{j} {H}_{j} {\vec{y}}_{j}$$

is a vector.

In summary, given a single page template and images to be placed in the image fields of the template, the parameters used to scale the images and white spaces of the template can be determined mined from the closed form equation for [symbol] ^{MAP}.

Once the parameters of the parameter vector [symbol] ^{MAP} are determined using the closed form equation for [symbol] ^{MAP}, the template is rendered by multiplying un-scaled dimensions of the images and widths of the white spaces by corresponding parameters of the parameter vector [symbol] ^{MAP}.

The elements of the parameter vector [symbol] ^{MAP} may also be subject to boundary conditions on the image fields and white space dimensions arising from the minimum width constraints for the margins. In other examples, in order to determine [symbol] ^{MAP} subject to boundary conditions, the vectors [symbol] ₁, and [symbol] ₂ the variances α₁⁻¹, α₂⁻¹, β₁⁻¹, and β₂⁻¹ the constants W₁, W₂, H₁, and H₂, are inserted into the linear equation A [symbol] ^{MAP}= [symbol] and the matrix equation solved numerically for the parameter vector [symbol] ^{MAP} subject to the boundary conditions on the parameters of [symbol] ^{MAP}. The matrix equation A [symbol] ^{MAP}= [symbol] can be solved using any numerical method in the art for solving matrix equations subject to boundary conditions on the vector [symbol] ^{MAP}, such as the conjugate gradient method.

### Implementation and Constraint

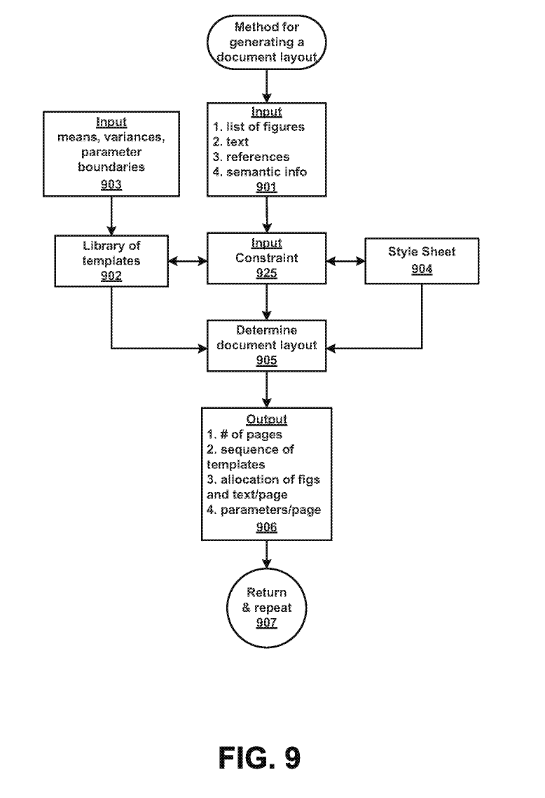

FIGS. 9-11 show control-flow diagrams summarizing computational steps of just one method using belief propagation in an automated process of generating a document layout. Examples herein are not limited to the specific order in which the following steps are presented. In other examples, the order in which the steps are performed can be changed without deviating from the scope of examples described herein.

Additionally, in one example, FIGS. 9-11 further show a method for adjusting the automatic template layout by providing a constraint. In other words, one example provides an aspect of interaction or constraint for a layout otherwise automatically rendered via the probabilistic layout optimization engine. In general, the constraint may be global, local or specific. In other words, the constraint may affect the entire document, a single page of the document, some but not all of the pages of the document, a specific portion of a template for each page of the document, a specific block in the document, or the like.

In one example, the constraint is provided, post-process. For example, an initial layout is provided and one or more adjustments to the layout are provided in a semi-automated manner. In another example, the constraint may be provided pre-process. In yet another example, a plurality of constraints may be provided and they may be provided pre-process, post-process or a combination thereof.

Examples of the type of constraint that may be given include, but are not limited to, changing the template, resizing one or more images, manipulate whitespace, define a number of pages within which the layout should fit, and the like.

The document is then rendered with text and figures allocated to each page within appropriate template fields of the template selected for each page while abiding by the constraint. If the constraint occurs post process, then one example provides the framework to accomplish these tasks by automatically reflowing the layout after receiving the constraint. The optimization may be global or fast and localized.

FIG. 9 shows a control-flow diagram of an example method for generating a document layout. In block 901, a raw list of figures, text, references, and semantic information is input, as described above with reference to FIG. 6. The raw input at 901 does not include instructions regarding which text, figures, and references are to be selected for each page or even how text, figures, and references are to be arranged on each page. At 902, a library of templates is input, as described above with reference to FIG. 6. In block 903, mean values corresponding to the widths Wᵢ and Hⱼ, the variances αᵢ⁻¹ and βⱼ⁻¹, and bounds for the parameters of the parameter vector [symbol] can also be input with the library of template.

With reference to 904, a style sheet corresponding to the document's overall appearance is input. The style sheet may include (1) a typeface, character size, and colors for headings, text, and background; (2) format for how front matter, such as preface, figure list, and title page should appear; (3) format for how sections can be arranged in terms of space and number of columns, line spacing, margin widths on all sides, and spacing between headings just to name a few; and (4) any boilerplate content included on certain pages, such as copyright statements. The style sheet typically applies to the entire document. As necessary, specific elements of the style sheet may be overridden for particular sections of the document.

With reference now to 925 of FIG. 9, a constraint input is checked prior to determining the document layout 905. However, if the constraint is received post-process, that is, after rendering of the document has occurred, the constraint input will cause a re-rendering of the document with text and figures allocated to each page within appropriate template fields of the template selected for each page while abiding by the added constraint.

In one example, the constraint 925 of the document may include, but is not limited to, constraining a number of document pages Aₚ, constraining one or more template selections Tⱼ, constraining one or more scalable template fields [symbol] ⱼ and the like. Additionally, in one example, there may be a plurality of constraints 925. Further, the constraints may or may not overlap in size, scope, and control.

In one example, constraining one or more template selections Tⱼ may include limiting the template selection to a single template, a small group of templates, or removing one or more templates from the selectable group. In one example, to apply a template constraint, one or more of the non-selected highest ranked templates may be offered as options for the different template. For example, one or more of the possible template options would be provided to the user via a GUI, or the like, and the user would select the new template(s) by clicking on one or more of the possible template options. After selecting the specific template or number of templates, the document generating process would be repeated with the new template constraint. In one example, if the constraint is a specific constraint, the single page would be re-generated while the rest of the document would remain unchanged. If the constraint were a local constraint, the single page plus one or more pages before or after the single page would be re-generated while the remainder of the document would remain unchanged. If the constraint were global, then the entire document would be regenerated with the template constraint being applied for the appropriate page.

In one example, constraining one or more scalable template fields [symbol] ⱼ of the document may include, constraining an image, a margin, an amount of white space, a text size, and a text font. Further, the constraint may make the scalable template fields [symbol] ⱼ larger or smaller. Again, it is also possible that a first constraint would make a first image larger while a second constraint may make a second image smaller, or vice-versa. In other words, the technology is well suited to providing a number of scalable field constraints on a single page, on a local number of pages, or globally over the entire document.

In one example, the application of each constraint may be global to the document, a single page constraint of the document, a plurality of objects constraint, a single object constraint, a localized portion of the document, the localized portion comprising more than a single page and less than the entire document, and the like.

In one example, the global solution may restrict the choice of templates for the affected page. However, the algorithm that optimizes template parameters is still performed. In so doing, allocation to the affected page is allowed to change and allowed to propagate to all pages.

With respect to the page or local solution, one example will fix allocation for the affected page. For example, instead of performing a global reflowing, one example will optimize template parameters given the new template and the old allocation on the specific page being constrained. In other words, the template may have been changed, or an image resized, but the allocation on the constrained page will remain equal to the allocation on the previous version of the page.

Local neighborhood solution refers to fixing allocation over a small neighborhood. For example, 1 page before and 1 page after the constrained page. In one example, global optimization will be run on the neighborhood. In one example, during the running of the local neighborhood optimization, specialized first/last page behaviors will be turned off.

For example, the constraint may be to change the template for a given page. As shown in FIG. 9, input constraint 925 has access to the library of templates 902, style sheet 904 and the determine document layout 905. In one example, the constraint may be a negative constraint, such as; pan 2 should not use the same template as pages 1 and 3-5. In another example, the constraint may be a specific constraint such as; page 2 should be rendered on template 17 while no template guidance is provided for pages 1 and 3-5. In yet another example, the constraint may be a group-type constraint such as page 2 should be rendered from a different one of a set of high-scoring templates, while the template(s) utilized for pages 1 and 3-5 are not so constrained.

In block 905, a subroutine called “determine document layout” is called. The subroutine uses an automated method for determining an optimized document layout described below with reference to FIG. 9.

In block 906, a document with an optimized layout is output. The document layout includes an optimized allocation of text and images per page, optimized templates for each page, and optimized scaling of images and other design elements including whitespaces. In block 907, blocks 901-906 can be repeated for a different document.

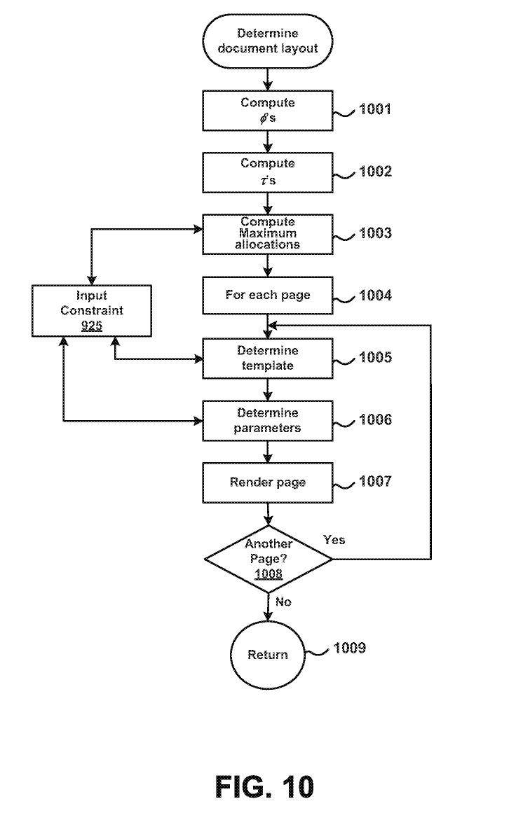

FIG. 10 shows a control-flow diagram of an example method corresponding to the subroutine “determine document layout” called in block 905 of FIG. 9. In block 1001, the φ's associated with equation (1) are computed. The φ's can be determined as described using a local conditional page model that is the product of layout quality, reference quality, and page qualities probabilities whose parameters are set by the document designer. In block 1002, a set of τ's are determined recursively as described above.

In block 1003, optimal allocations A₀*, A₁*, . . . , Aₚ*, that contribute to P*({Tⱼ}, { [symbol] ⱼ}, {Aⱼ}) are determined using reverse recursion, as described above. However, it is noted that at 1003, a check for any input constraints 925 with respect to the number of pages is performed. If no constraint is provided, then optimal allocation using reverse recursion occurs. However, in one example, if the number of pages is constrained to a specific page number, then the forward process can be stopped at the designated page number and then the reverse recursion occurs. In other words, P* would become a specific P* and the reverse recursion occurs.

In one example, if the number of pages is constrained to a range of page numbers, then the optimal allocations A₀*, A₁*, . . . , Aₚ*, that contribute to P*({Tⱼ}, { [symbol] ⱼ}, {Aⱼ}) can be determined over the allowable range of page numbers then the forward process can be stopped at the designated page number and then the reverse recursion occurs.

Block 1004 is a for-loop that repeats blocks 1005-1007 for each page of the document.

At 1005, in one example, a template is determined using equation (2). However, at 1005 a check for any input constraints 925 with respect to the template type is performed. If no constraint is provided, then a template is determined using equation (2). In one example, if the choice of templates is constrained to a specific template, then 1005 would receive the template selection from input constraint 925. However, in one example, if the number of templates is constrained to a range of templates, or certain pages have template constraints thereon, then the template may be determined using equation (2) over the allowable templates on a per page basis.

In other words, the restriction of the parameters can be easily enforced by equating the upper and lower bounds of equation (2) to the desired parameter values. In one example, the same or different input constraint 925 may be provided at each page of the repeating for-loop of 1005-1007.

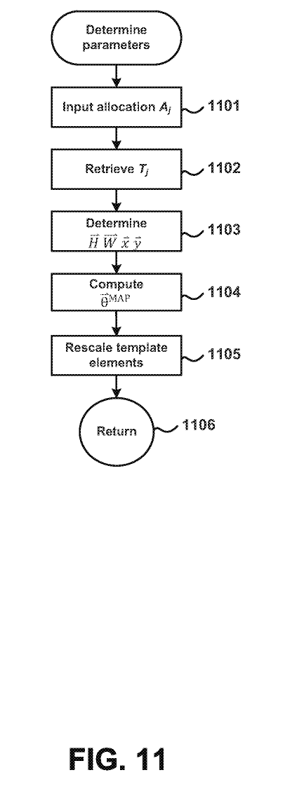

In block 1006, a subroutine “determine parameters” is called. This subroutine produces a set of optimized template parameters for each template determined in block 1005. However, at 1006 a check for any input constraints 925 with respect to the optimized template parameters for each template type is performed. If no constraint is provided, then optimized template parameters may be determined using the discussion provided with respect to FIG. 11 and equation (3). In one example, if the choice of one or more optimized template parameters is constrained to a specific template parameter, then 1006 would receive the template parameter selection directly from input constraint 925. However, in another example, if the optimized template parameters are constrained to a range of parameters, then the optimized template parameters may be determined using FIG. 11 and equation (3) as constrained over the allowable optimized template parameters on a per object basis.

In other words, the restriction of the parameters can be easily enforced by equating the upper and lower bounds of equation (3) to the desired parameter values. Thus, in one example, at each page of the repeating for-loop of 1005-1007, input constraint 925 may provide information that would affect optimized template parameters for one or more objects or white space on the given template page.

In block 1007, a page is rendered with the optimized template and corresponding template parameters. The template page can be rendered by exhibiting the page on monitor, television set, or any other suitable display, or the template page can be rendered by printing the page on a sheet of paper. In block 1008, when the document includes another page, blocks 1005-1007 are repeated, otherwise the subroutine returns to “determine document layout” in FIG. 9.

FIG. 11 shows a control-flow diagram of an example method corresponding to the subroutine “determine parameters” called in block 1006 of FIG. 10. In block 1101, streams of text and figures data associated with an allocation are input. In block 1102, a template corresponding to the page determined in block 1005 of FIG. 10 is retrieved. In block 1103, elements of the vectors [symbol] , and [symbol] are determined as described in the subsection Template Parameters. Mean values [symbol] ᵢ and [symbol] ⱼ, variances αᵢ⁻¹ and βⱼ⁻¹, and bounds for the parameters of the parameter vector [symbol] input in block 903 of FIG. 9 are retrieved for computation in the following. In block 1104, the parameter vector [symbol] ^{MAP} that maximizes the posterior probability P( [symbol] | [symbol] ) is determined as described above.

Elements of the parameter vector [symbol] ^{MAP} can be determined by solving the matrix equation A [symbol] ^{MAP}= [symbol] for [symbol] ^{MAP} using the conjugate gradient method or any other matrix equation solvers in the art where the elements of the vector [symbol] ^{MAP} are subject to boundary conditions, such as minimum constraints placed on the margins. In block 1105, once the parameter vector [symbol] is determined, resealed dimensions of the block objects and widths of the white spaces can be obtained by multiplying dimensions of the template elements by the corresponding parameters of the parameter vector [symbol] ^{MAP}. In block 1106, the subroutine returns to the subroutine “determine document layout” of FIG. 10.

in one example, the constraints may be provided prior to an initial document layout. For example, any or all of the number of pages, or range of pages for the document; the pool of templates from which one or more pages of the document may be selected; and one or more image scaling constraints may be provided.

In another example, the constraints may be provided after a document has been generated. For example, after viewing the generated document, a user may adjust an image, for example, by selecting a corner of an image on a GUI and then dragging the corner to rescale the image. In another example, one or more pages of a generated document may be selected by the user and a template change may be invoked. In the following example, a single page of the document being changed is described for clarity; however, the change may also be performed on a number of document pages or for the entire document. Moreover, if the template changes are provided to more than one page in the document, each page that is changed in the document may be changed to the same new template, changed to one of a selected plurality of templates, changed to a different template, or any combination thereof.

In one example, invoking a template change may include the user designating the page of the document to be changed. Such as via a GUI, or the like. In one example, when a change to the template is invoked, one or more of the non-selected highest ranked templates may be offered as options for the template change. For example, one or more of the possible template options would be provided to the user via a GUI, or the like, and the user would select the new template(s) by clicking on one or more of the possible template options. After selecting the specific template or number of templates, the document generating process would be repeated with the new template constraint. In one example, if the constraint is a specific constraint, the single page would be re-generated while the rest of the document would remain unchanged. Similarly, if the constraint were a local constraint, the single page plus one or more pages before or after the single page would be re-generated while the remainder of the document would remain unchanged. If the constraint were global, then the entire document would be regenerated with the template constraint being applied for the appropriate page.

In one example, after viewing the generated document, the user may select a different page number. For example, if the generated document had 7 pages, the user may invoke a constraint on the document to reduce or increase the total page count. For example, the user may constrain the document to 5 pages, 8 pages, 6 pages or less, etc. After receiving the page number constraint the document would be regenerated with the page number constraint being applied.

Although the post document generation constraints are described in single case examples, e.g., a template change, a page number change, and an image resizing change, more than one of the constraints may be selected. For example, a user may constrain the page count of a generated document and also resize an image within the document. The document would then be re-generated while adhering to both the page constraint and the image resize constraint. In other words, the constraints that may be applied are not limited to a single type of constraint, but may include any number of constraints.

Additionally, the constraints may include pre-document generation constraints as well as post document generation constraints. For example, prior to the first generation of the document a constraint such as image size may have been provided. After the document was generated and provided, a page number constraint may be introduced. The re-generated document would then include both the image size constraint as well as the page number constraint.

In one example, the constraints may be changed or removed between document revisions. Utilizing the above example, the re-generated document included an original image size constraint and a later added page number constraint. Upon review of the re-generated document, the user may change the image size constraint. The document would then be re-generated with the page number constraint but without the image size constraint. This process could continue for n number of iterations that may include n number of constraints, changes to constraints, removal of constraints, and the like.

### Computer System

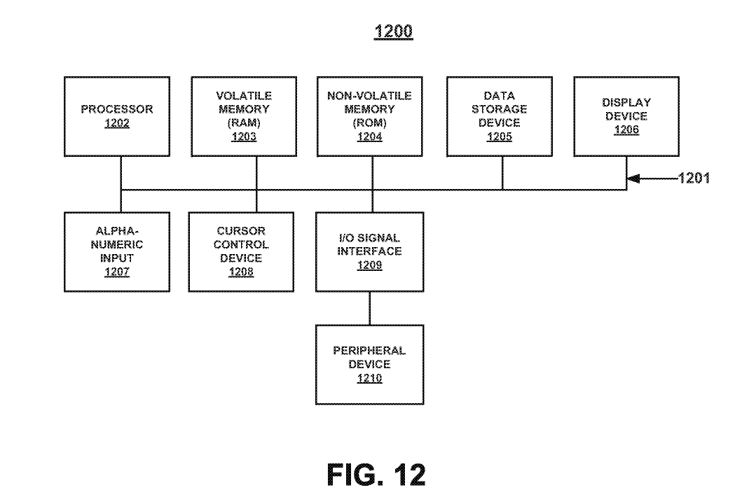

With reference to FIG. 12, certain portions are comprised of computer-readable and computer-executable instructions that reside, for example, in computer system 1200 which is used as a part of a general purpose computer network (not shown). It is appreciated that computer system 1200 of FIG. 12 is an example and that the systems and methods disclosed herein can operate within a number of different computer systems including general-purpose computer systems, embedded computer systems, laptop computer systems, hand-held computer systems, and stand-alone computer systems.

In this example, computer system 1200 includes an address/data bus 1201 for conveying digital information between the various components, a central processor unit (CPU) 1202 for processing the digital information and instructions, a volatile main memory 1203 comprised of volatile random access memory (RAM) for storing the digital information and instructions, and a non-volatile read only memory (ROM) 1204 for storing information and instructions of a more permanent nature. In addition, computer system 1200 may also include a data storage device 1205 (e.g., a magnetic, optical, floppy, or tape drive or the like) for storing vast amounts of data. It should be noted that the software program for creating an editable template from a document image can be stored either in volatile memory 1203, data storage device 1205, or in an external storage device (not shown).

Devices which can be coupled to computer system 1200 include a display device 1206 for displaying information to a computer user, an alpha-numeric input device 1207 (e.g., a keyboard), and a cursor control device 1208 (e.g., mouse, trackball, light pen, etc.) for inputting data, selections, updates, etc. Computer system 1200 can also include a mechanism for emitting an audible signal (not shown).

Returning still to FIG. 12, examples of display device 1206 of FIG. 12 may be a liquid crystal device, cathode ray tube, or other display device suitable for creating graphic images and alpha-numeric characters recognizable to a user. A cursor control device 1208 allows the computer user to dynamically signal the two dimensional movement of a visible symbol (cursor) on a display screen of display device 1206. Examples of cursor control device 1208 include a trackball, mouse, touch pad, joystick, or special keys on alpha-numeric input 1207 capable of signaling movement of a given direction or manner displacement. Alternatively, it will be appreciated that a cursor can be directed and/or activated via input from alpha-numeric input 1207 using special keys and key sequence commands. Alternatively, the cursor may be directed and/or activated via input from a number of specially adapted cursor directing devices.

Furthermore, computer system 1200 can include an input/output (I/O) signal unit (e.g., interface) 1209 for interfacing with a peripheral device 1210 (e.g., a computer network, modem, mass storage device, etc.). Accordingly, computer system 1200 may be coupled in a network, such as a client/server environment, whereby a number of clients (e.g., personal computers, workstations, portable computers, minicomputers, terminals, etc.) are used to run processes for performing desired tasks. In particular, computer system 1200 can be coupled in a system for creating an editable template from a document.

A number of embodiments of the present invention are thus described. While the present invention has been described in particular embodiments, it should be appreciated that the present invention should not be construed as limited by such embodiments, but rather construed according to the following claims.

What is claimed is:

1. A method for adjusting an automatic template layout by providing a constraint, the method comprising:
receiving raw text, figures, references, and semantic information (901);
checking for a constraint (925);
determining an allocation (1003) of text and figures for each page of a document;
for each page of the document,
determining a template (1005) for displaying the allocation assigned to the page;
scaling template fields (1006) to exhibit the text and figures assigned to the page; and
rendering (1007) the document with text and figures allocated to each page within appropriate template fields of the template selected for each page while abiding by said constraint.

2. The method of claim 1 further comprising:
receiving said constraint prior to rendering the document; and
utilizing said constraint when generating said document.

3. The method of claim 1 further comprising:
receiving said constraint after rendering the document; and
performing a re-rendering of the document with text and figures allocated to each page within appropriate template fields of the template selected for each page while abiding by said constraint.

4. The method of claim 1 further comprising:
constraining said document to a selected number of pages; and
rendering the document with text and figures allocated to each page within appropriate template fields of the template selected for each page while abiding by said selected number of pages constraining.

5. The method of claim 1 further comprising:
constraining one or more pages of said document to a selected template; and
rendering the document with text and figures allocated to each page within appropriate template fields of the template automatically selected for each page not under constraint while utilizing the selected template on said one or more constraining pages.

6. The method of claim 1 further comprising:
constraining one or more template fields of said document to a selected scale; and
rendering the document with text and figures allocated to each page within appropriate template fields of the template automatically selected for each page not under constraint while utilizing the selected, scale on the one or more template fields of said constraining.

7. The method of claim 6 wherein said constraining one or more template fields of said document to a selected scale is selected from the group of template fields consisting of: an image block, a margin, an amount of white space, a text size, and a text font.

8. The method of claim 1 further comprising:
applying a global constraint to the document.

9. The method of claim 1 further comprising:
applying said constraint to a single page of the document.

10. The method of claim 1 further comprising:
applying said constraint to a localized portion of the document, said localized portion comprising more than a single page and less than the entire document.

11. A computer-readable medium having instructions encoded thereon for enabling a processor to perform a method for adjusting an automatic template layout by entering a constraint, the method comprising:
receiving raw text, figures, references, and semantic information (901);
receiving a constraint (925);
determining an allocation (1003) of text and figures for each page of a document;
for each page of the document,
determining a template (1005) for displaying the allocation assigned to the page;
scaling template fields (1006) to exhibit the text and figures assigned to the page; and
rendering (1007) the document with text and figures allocated to each page within appropriate template fields of the template selected for each page.

12. The computer-readable medium of claim 11 further comprising:
receiving said constraint after rendering the document; and
performing a re-rendering of the document with text and figures allocated to each page within appropriate template fields of the template selected for each page while abiding by said constraint.

13. The computer-readable medium of claim 11 wherein said constraint is selected from the group consisting of: constraining a number of pages of said document, constraining one or more pages of said document to a selected template, and constraining one or more template fields of said document to a selected scale.

14. The computer-readable medium of claim 13 wherein said constraining one or more template fields of said document to a selected scale is selected from the group consisting of: an image block, a margin, an amount of white space, a text size, and a text font.

15. The computer-readable medium of claim 11 wherein an application of said constraint is selected from the group consisting of: a global constraint of the document, a single page constraint of the document, a plurality of objects constraint, a single object constraint, and a localized portion of the document, said localized portion comprising more than a single page and less than the entire document.
